(19) United States
(12) Patent Application Publication
(10) Pub. No.: US 2025/0216572 A1
(43) Pub. Date: Jul. 3, 2025

(54) Seismic Volume Combination

(71) Applicant: BP EXPLORATION OPERATING COMPANY LIMITED, Middlesex (GB)

(72) Inventor: Alistair George Crosby, London (GB)

(73) Assignee: BP EXPLORATION OPERATING COMPANY LIMITED, Middlesex (GB)

(21) Appl. No.: 18/987,959

(22) Filed: Dec. 19, 2024

(30) Foreign Application Priority Data
Dec. 28, 2023 (GB) 2320103.1

(51) Int. Cl. G01V 1/34; G01V 1/36

(52) U.S. Cl. CPC G01V 1/345; G01V 1/364

(57) ABSTRACT

A method includes receiving a first and a second volume generated based on seismic dataset, performing spectral shaping on the first and second volume to generate first and second shaped and phase aligned volumes, wherein phase alignment is with respect to the second volume, determining a frequency band in which to combine the first shaped and phase aligned volume with the second shaped and phase aligned volume, performing filtering on the first and second shaped and phase aligned volumes in the frequency band to generate first and second filtered, shaped and phase aligned volumes in the frequency band, and generating a combined seismic image based at least in part on the first and second filtered, shaped and phase aligned volumes in the frequency band, wherein the combined seismic image represents hydrocarbons in a subsurface region of Earth or subsurface drilling hazards.

### CROSS-REFERENCE TO RELATED APPLICATIONS

This application claims priority to U.K. Application No. 2320103.1 filed on Dec. 28, 2023, and entitled “Seismic Volume Combination,” which is hereby incorporated herein by reference in its entirety for all purposes.

### BACKGROUND

The present disclosure relates generally to analyzing seismic data, and more specifically, to utilizing improved seismic inversion techniques in prediction of reservoir properties.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Processing of seismic data generally results in the generation of an image of the acoustic reflectivity of the subsurface (i.e., an event). However, it is desirable to instead have a measure of the impedance of a formation (i.e., a measure of a hardness of the formation). That is, instead of generating an indication of boundaries between layers of a formation, it is desirable to instead to determine where the layers of a formation themselves are located.

One technique to generate the impedance of a formation is to apply a post-stacking inversion technique. This operates to transform seismic information volumes into acoustic impedance volumes utilizing seismic data, well data, and interpretations. One example of a post-stacking inversion technique to approximate an impedance profile is colored inversion (e.g., a technique for band-limited inversion of seismic data), which can be applied in the processing of seismic data. Generally, this is performed as part of a two-step process of making an adjustment to the phase of the data and taking a spectrum of data and shaping it to match well data from the field. The effect of step two in implementing colored inversion is to boost low frequency values in the data.

However, migration and post-stack inversion techniques typically experience noise at low frequencies, which can render the processed data at these low frequencies unusable. Thus, migration and post-stack inversion techniques can generally process seismic data between approximately 5 Hz-100 Hz (or greater values) accurately. However, at frequencies lower than approximately 5 Hz (e.g., frequencies that best capture the thickest beds of a formation), migration and post-stack inversion techniques generate results that can have too much noise to be generally useful in characterizing a reservoir.

Alternative techniques can be applied to process the seismic data. For example, Full Waveform Inversion (FWI) can be applied to process seismic data. In place of generating an image based on seismic data, FWI generates a model of the velocity of acoustic seismic waves. FWI can generally process seismic data between approximately 0 Hz-15 Hz accurately, but at higher frequencies, the cost of generating of FWI processed data increases greatly.

To overcome the above noted deficiencies in seismic processing, present embodiments are directed to the combination of FWI-derived velocities or reflectivity (FDR) with migrated images. This generates results that have less noise at low frequencies (e.g., at frequencies at or less than approximately 5 Hz) relative to migration and post-stack inversion techniques but still extended to higher frequencies (e.g., at frequencies at or greater than approximately 15 Hz) relative FWI processed data. These results, accordingly, provide broader band inversion and reflectivity products than would be possible if individually using migration and post-stack inversion results as an input value or FWI results as an input value for reservoir characterization.

In some embodiments, techniques can include spectral shaping being applied separately to the input volumes. In some embodiments, the spectral shaping may incorporate some target spectrum, e.g., from well logs. An assessment is then made of the frequency band over which the datasets overlap and any phase misalignment between the two is determined. Filters are then applied, which taper the two volumes together and optimally phase align then. The filtered outputs can then be summed to generate the final result. The generated result provides cleaner (i.e., less noisy) volumes with greater bandwidth and geological fidelity than would be achievable if migration and post-stack inversion results as or FWI results were applied in isolation.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 illustrates a marine survey system in a marine environment;

FIG. 3 illustrates a land survey system in a land environment;

FIG. 4 illustrates a computing system that may perform operations described herein based on data acquired via the marine survey system of FIG. 2 and/or the land survey system of FIG. 3; and

FIG. 5 illustrates a flow chart describing combining seismic volumes, in accordance with embodiments presented herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

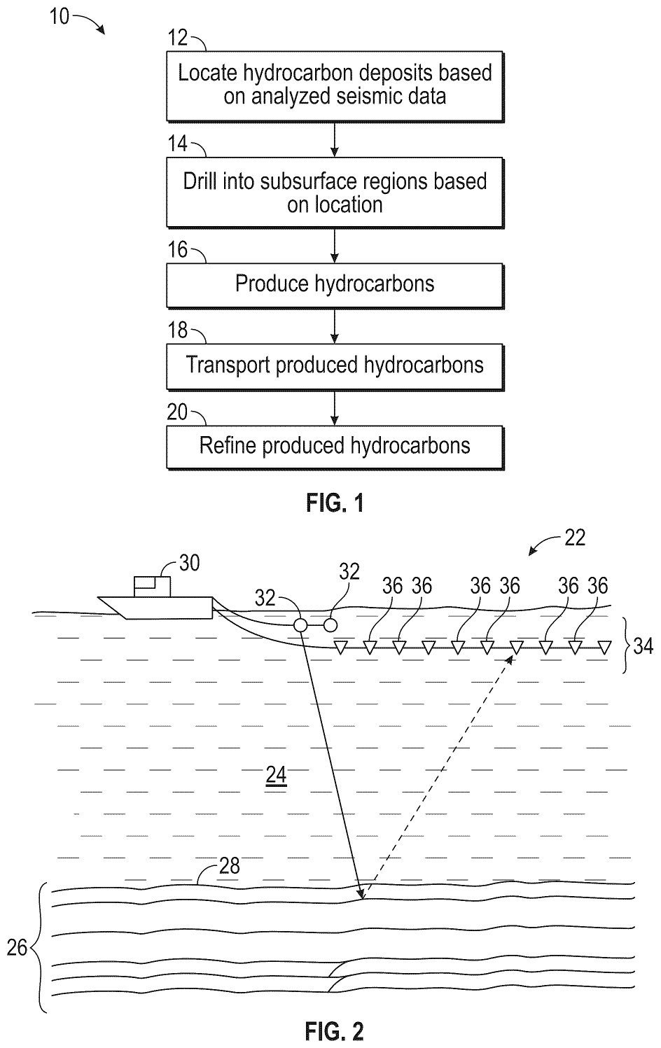

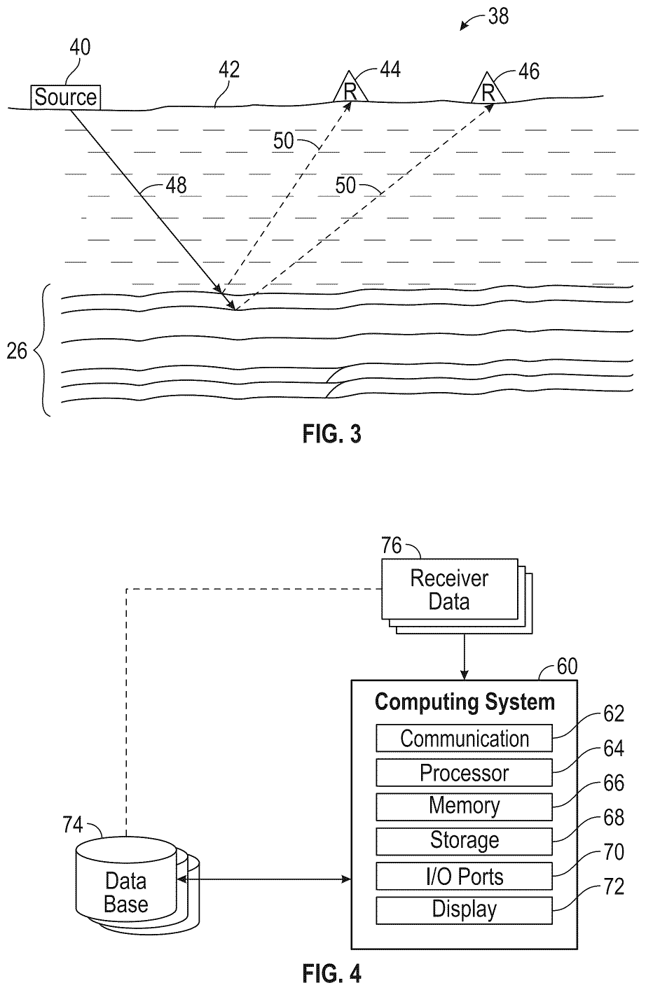

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26, the energy output by the land-based seismic source 40 may be reflected off of the geological formations and acquired or recorded by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first receiver 44 may receive the reflection of the seismic waveform 48 off of one geological formation and a second receiver 46 may receive the reflection of the seismic waveform 48 off of a different geological formation. As such, the first receiver 44 may receive a reflected seismic waveform 50 and the second receiver 46 may receive a reflected seismic waveform 52.

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data. More generally, the acquired seismic data can be applied to characterize a subsurface region 26 of the Earth. In this manner, it can be applied in a number of geological systems, including geothermal, wind pylon siting, other elements of the hydrocarbon systems such as seals, source rocks, etc. and in, for example, reservoir characterization.

In some embodiments, the results of the seismic data analysis may be generated in conjunction with a seismic processing scheme that includes seismic data collection, editing of the seismic data, initial processing of the seismic data, signal processing, conditioning, and imaging (which may, for example, include production of imaged sections or volumes) prior to any interpretation of the seismic data, any further image enhancement consistent with the exploration objectives desired, generation of attributes from the processed seismic data, reinterpretation of the seismic data as needed, and determination and/or generation of a drilling prospect or other seismic survey applications. As a result, location of hydrocarbons within a subsurface region 26 may be identified. Additionally, it may be desirable to estimate reservoir or formation properties of a subsurface region 26. Techniques for reservoir characterization are described herein (although it should be noted that these techniques may additionally and/or alternatively be applied to a number of geological systems, including geothermal, wind pylon siting, other elements of the hydrocarbon systems such as seals, source rocks, etc. and, more generally applied in characterizing a subsurface region 26 of Earth).

Present embodiments are directed to the combination of FWI-derived velocities or reflectivity (FDR) as a first volume and migrated images as a second volume to obtain cleaner and broader band inversion and reflectivity products than would be possible using each input individually. This allows, for example, for more accurate reservoir characterizations.

The input volumes may be combined in several ways. For example, the two inputs can be FDR (which, for example, can be generated by taking a gradient of the FWI velocity model) and migrated seismic data. The output generated from these inputs can be reflectivity with greater broadband accuracy relative to reflectivity that could be generated using either of the FDR and the migrated seismic data alone. This output can be useful, for example, to map the structure of the data (e.g., map out boundaries between the layers and/or faults to map the structure of the subsurface). Another example of the inputs can be FWI velocities and inverted migrated seismic data. The output generated from these inputs can be velocity with greater broadband accuracy relative to any velocity that could be generated using either of the FWI velocities and the inverted migrated seismic data alone. This output can be useful, for example, to understand the rock properties of the layers themselves with a greater emphasis on the velocities provided. As another example the two inputs can be FDR and migrated seismic data and the output generated from these inputs can be a colored inversion (CI) with greater broadband accuracy relative to any colored inversion that could be generated using either of the FDR and the migrated seismic data alone. This output differs from, for example, combining FWI velocities and inverted migrated data in that it lacks a background trend. In this manner, for example, thicker beds have greater standout.

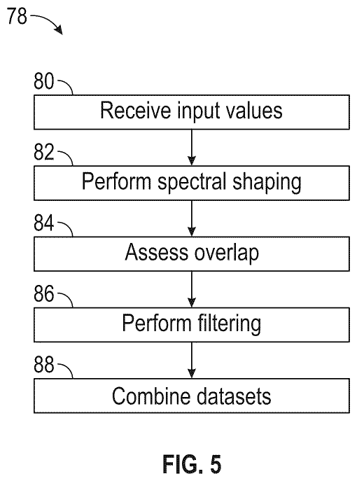

FIG. 5 illustrates flow chart of a method 78 as a technique for reservoir characterization. The method 78, as well as the techniques previously described, can be implemented and/or performed by the computing system 60, although it should be understood that the method 78 (as well as the techniques previously discussed) may be performed by any suitable computing system, computing device, and/or the like. In this way, it should also be understood that some or all of the below described processing operations may be performed by one or more components of the computing system 60, including the processor 64, the memory 66, or the like, and may be executed by the processor 64, for example, executing code, instructions, commands, or the like stored in the memory 66 (e.g., a tangible, non-transitory, computer-readable medium).

As will be discussed herein, method 78 operates to combine FWI-derived velocities or reflectivity (FDR) and migrated images to obtain cleaner and broader band inversion and reflectivity products than would be possible using each input individually. In step 80, the input volumes are received. As noted above, these input volumes can be, for example, FDR and migrated seismic data (e.g., migrated images) or FWI velocities and inverted migrated seismic data. In step 82, spectral shaping of each of the received input volumes is performed. In one embodiment, the spectral shaping may incorporate a target spectrum, for example, derived from well logs.

In step 84, an assessment performed of the frequency band over which the datasets overlap. This assessment can include a determination of a threshold signal to noise ratio (i.e., an acceptable signal to noise ratio) of the frequency band over which the datasets overlap as part of determining the portions of overlap. Additionally and/or alternatively, step 84 can include a determination of whether phase misalignment between the two input volumes is present.

In step 86, filtering of the resultant data from step 86 is performed. This filtering can be selected to taper the two volumes together. Additionally, phase alignment of the volumes (when it is determined in step 84 that phase misalignment between the two input volumes is present) can be performed in prior to the filtering in step 86. In step 88, the filtered outputs from step 86 are summed to generate the final result, which can be a reservoir characterization. The generated result provides cleaner (i.e., less noisy) volumes with greater bandwidth and geological fidelity than would be achievable if migration and post-stack inversion results or FWI results were applied in isolation.

An example of implementation of method 78 with respect to two input volumes will be discussed below. In the present discussion, the two inputs are FDR and migrated seismic data and the output generated from these inputs is a colored inversion with greater broadband accuracy relative to any CI that could be generated using either of the FDR and the migrated seismic data alone. In this manner, method 78 provides for an extension of the CI process, whereby the phase and amplitude spectrum of a seismic volume (e.g., cropped around a target of interest) is shaped (and phase aligned) to match the impedance spectrum calculated from well logs in that area.

In step 80, the FDR and migrated seismic data as input volumes are received. The spectrum of each data set (e.g., their amplitude spectrum) can be examined and compared against, for example, impedance measured down well. In step 82, spectral shaping of each of the received input volumes is performed against a given dataset, for example, the impedance measured down well as a target spectrum derived from well logs.

Thereafter, in conjunction with step 84, an assessment of both shaped data is performed. This assessment determines the frequency band over which the datasets overlap so as to determine the frequency band at which to merge the datasets. Selection of this band can include a truncation of the frequency band at one or both of the edges of the band so as to reduce the possibility of amplifying noise at the ends of the datasets in the frequency band. In this manner, the assessment can include a determination of a threshold signal to noise ratio (i.e., an acceptable signal to noise ratio) of the frequency band over which the datasets overlap as part of determining the portions of overlap in step 84. Additionally and/or alternatively, step 84 can include a determination of whether phase misalignment between the two input volumes is present. When it is determined that phase misalignment between the two input volumes is present, the volumes can be phase aligned so that events match. This can be performed in conjunction with step 84 or step 86 (i.e., before the filtering operation of step 86).

In step 86, filtering of the resultant data from step 86 is performed. As part of step 86, spectral tapers may be generated, designed, or selected for each dataset. These tapers operate to reduce the likelihood of boosting noise and can be selected to that the sum of the data sets always is equal to a set value (e.g., 1). For example, at one end of the overlapping frequency band, 80% of a combination of the data can be from the FDR. The tapers can insure that the portion of the sum of the datasets attributable to the migrated seismic data is 20%. Conversely, at the other end of the overlapping frequency band, for example, 90% of a combination of the data can be from the migrated seismic data and the tapers can be selected to insure that the portion of the sum of the datasets attributable to the FDR is 10%.

In step 88, the filtered outputs from step 86 are summed to generate the final result, which can be a reservoir characterization (or can be used in the generation of a reservoir characterization). The generated result includes elements of both datasets and provides cleaner (i.e., less noisy) volumes with greater bandwidth and geological fidelity than would be achievable if migration and post-stack inversion results or FWI results were applied in isolation.

While implementation of method 78 has been discussed as being implemented and/or performed by the computing system 60 or any suitable computing system, computing device, and/or the like, in some embodiments, one or more of the steps of method 78 can be impacted by inputs received from a user. For example, a user could select which wells to match to, which portions of the spectrum overlap, determining the final overlap zone, and/or review the phase alignment that is performed. However, one or more of these operations, as noted above, can be performed by the computing system 60 or any suitable computing system, computing device, and/or the like.

A related instance of the techniques described herein is an extension of the process of spectral blueing, whereby the spectrum of a migrated seismic volume is shaped, and, for example, phase aligned, to match the reflectivity spectrum calculated from well logs. Low frequencies are less amplified by blueing than they are by CI, but nevertheless there is utility in using both FWI and migrated datasets in this process to achieve a more broadband wavelet.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving a first volume generated based on a seismic dataset;
receiving a second volume generated based on the seismic dataset;
performing spectral shaping on the first volume to generate a first shaped and phase aligned volume, wherein phase alignment is with respect to the second volume;
performing spectral shaping on the second volume to generate a second shaped and phase aligned volume;
determining a frequency band in which to combine the first shaped and phase aligned volume with the second shaped and phase aligned volume;
performing filtering on the first shaped and phase aligned volume and the second shaped and phase aligned volume in the frequency band to generate a first filtered, shaped and phase aligned volume and a second filtered, shaped and phased aligned volume in the frequency band; and
generating a combined seismic image based at least in part on the first filtered, shaped and phase aligned volume and the second filtered, shaped and phase aligned volume in the frequency band, wherein the combined seismic image represents hydrocarbons in a subsurface region of Earth or subsurface drilling hazards.

2. The method of claim 1, wherein performing spectral shaping on the first volume comprises modifying the first volume in view of a target spectrum.

3. The method of claim 2, wherein modifying the first volume in view of the target spectrum comprises utilizing a spectrum derived from a well log as the target spectrum.

4. The method of claim 1, wherein determining the frequency band in which to combine the first shaped and phase aligned volume with the second shaped and phase aligned volume comprises assessing a region over which frequencies of the first shaped and phase aligned volume overlap with frequencies of the second shaped and phase aligned volume.

5. The method of claim 4, wherein determining the frequency band in which to combine the first shaped and phase aligned volume with the second shaped and phase aligned volume is preceded by determining whether there is a phase misalignment between the first volume and the second volume.

6. The method of claim 5, comprising aligning a phase of the first volume and a phase of the second volume to a common phase when the phase misalignment between the first volume and the second volume is determined.

7. The method of claim 1, wherein performing filtering on the first shaped and phase aligned volume and the second shaped and phase aligned volume in the frequency band comprises spectrally tapering the first shaped and phase aligned volume and the second shaped and phase aligned volume in the frequency band.

8. The method of claim 1, wherein generating the combined seismic image based at least in part on the first shaped and phase aligned volume and the second shaped and phase aligned volume in the frequency band comprises generating the combined seismic image based at least in part on a result of a summation of the first filtered, shaped and phase aligned volume and the second filtered, shaped and phase aligned volume in the frequency band.

9. A tangible, non-transitory, machine-readable media, comprising instructions configured to cause a processor to:
receive a first volume generated based on a seismic dataset;
receive a second volume generated based on the seismic dataset;
perform spectral shaping on the first volume to generate a first shaped and phase aligned volume, wherein phase alignment is with respect to the second volume;
perform spectral shaping on the second volume to generate a second shaped and phase aligned volume;
receive an indication of a frequency band in which to combine the first shaped and phase aligned volume with the second shaped and phase aligned volume;
perform filtering on the first shaped and phase aligned volume and the second shaped and phase aligned volume in the frequency band to generate a first filtered, shaped and phase aligned volume and a second filtered, shaped and phased aligned volume in the frequency band; and
generate a combined seismic image based at least in part on the first filtered, shaped and phase aligned volume and the second filtered, shaped and phase aligned volume in the frequency band, wherein the combined seismic image represents hydrocarbons in a subsurface region of Earth or subsurface drilling hazards.

10. The tangible, non-transitory, machine-readable media, of claim 9, wherein the instructions configured to cause the processor to perform spectral shaping on the first volume comprise instructions to modify the first volume in view of a target spectrum.

11. The tangible, non-transitory, machine-readable media, of claim 10, wherein the instructions configured to cause the processor to modify the first volume in view of the target spectrum comprise instructions to utilize a spectrum derived from a well log as the target spectrum.

12. The tangible, non-transitory, machine-readable media, of claim 9, comprising instructions configured to cause the processor to align a phase of the first volume and a phase of the second volume to a common phase.

13. The tangible, non-transitory, machine-readable media, of claim 9, wherein the instructions configured to cause the processor to perform filtering on the first shaped and phase aligned volume and the second shaped and phase aligned volume in the frequency band comprise instructions to spectrally taper the first shaped and phase aligned volume and the second shaped and phase aligned volume in the frequency band.

14. The tangible, non-transitory, machine-readable media, of claim 9, wherein the instructions configured to cause the processor to generate the combined seismic image based at least in part on the first shaped and phase aligned volume and the second shaped and phase aligned volume in the frequency band comprise instructions to generate the combined seismic image based at least in part on a result of a summation of the first filtered, shaped and phase aligned volume and the second filtered, shaped and phase aligned volume in the frequency band.

15. A device, comprising:
a memory storing instructions; and
a processor coupled to the memory and configured to execute the instructions, which cause the processor to be configured to:
receive a first volume generated based on a seismic dataset;
receive a second volume generated based on the seismic dataset;
perform spectral shaping on the first volume to generate a first shaped and phase aligned volume;
perform spectral shaping on the second volume to generate a second shaped and phase aligned volume, where phase alignment is with respect to the second volume;
receive an indication of a frequency band in which to combine the first shaped and phase aligned volume with the second shaped and phase aligned volume;
perform filtering on the first shaped and phase aligned volume and the second shaped and phase aligned volume in the frequency band to generate a first filtered, shaped and phase aligned volume and a second filtered, shaped and phased aligned volume in the frequency band; and
generate a combined seismic image based at least in part on the first filtered, shaped and phase aligned volume and the second filtered, shaped and phase aligned volume in the frequency band, wherein the combined seismic image represents hydrocarbons in a subsurface region of Earth or subsurface drilling hazards.

16. The device of claim 15, wherein the processor is configured to perform spectral shaping on the first volume to modify the first volume in view of a target spectrum.

17. The device of claim 16, wherein the processor is configured to modify the first volume in view of the target spectrum utilizing a spectrum derived from a well log as the target spectrum.

18. The device of claim 15, wherein the processor is configured to align a phase of the first volume and a phase of the second volume to a common phase.

19. The device of claim 15, wherein the processor is configured to perform filtering on the first shaped and phase aligned volume and the second shaped and phase aligned volume in the frequency band by spectrally tapering the first shaped and phase aligned volume and the second shaped and phase aligned volume in the frequency band.

20. The device of claim 15, wherein the processor is configured to generate the combined seismic image by summing the first filtered, shaped and phase aligned volume and the second filtered, shaped and phase aligned volume in the frequency band.
